(19) United States
(12) Patent Application Publication
(10) Pub. No.: US 2021/0017750 A1
(43) Pub. Date: Jan. 21, 2021

(54) Toilet Chlorinator and Sanitizer

(71) Applicant: Javier G. Manrique, Greenacres, FL (US)

(72) Inventor: Javier G. Manrique, Greenacres, FL (US)

(21) Appl. No.: 16/512,618

(22) Filed: Jul. 16, 2019

(51) Int. Cl. E03D 9/03; C02F 1/68

(52) U.S. Cl. CPC E03D 9/038; C02F 2103/42; C02F 1/688

(57) ABSTRACT

A one piece apparatus for cleaning and sanitizing toilets comprising an elongated clip and a perforated canister; made out of plastic or similar hard material it is designed to work in a typical toilet application that includes an overflow tube inside the toilet tank plumbing parts.

The apparatus is attached to the overflow tube inside the toilet's tank using the clip part and keeping the canister part (where the chlorine tablet will be placed) partially submerged in the toilet tank water line.

Water from the toilet tank will flow through the perforated canister dissolving the chlorine tablet slowly thus feeding chlorine into the toilet water tank; this chlorinated water will pass through the toilet from the tank to the bowl in normal operation very time the toilet is flushed.

The Toilet Chlorinator and Sanitizer invention is a new way to clean and sanitize residential and commercial toilets by automatically applying chlorinated water from the toilet tank to the bowl every time the toilet is flushed.

Made out of plastic (or similar hard material) it will work in a typical toilet application that includes an overflow tube inside the toilet tank plumbing parts (see FIG. 6). The toilet Chlorinator and Sanitizer can be clipped (or inserted) to the overflow tube where the refill tube is normally attached, holding a small one inch chlorine tablet partially submerged in the toilet tank's water.

Water from the toilet tank will flow through the perforated canister part of the invention (see FIG. 1) dissolving the chlorine tablet slowly feeding chlorine into the toilet water tank; this chlorinated water will pass through the toilet from the tank to the bowl in normal operation every time the toilet is flushed.

The chlorine tablet must be replace when is completely dissolved into the water, during the test period with a prototype one chlorine tablet lasted for an average of 4 weeks in normal household operations, this may vary according to the number of toilet flushes and the amount of water flow through the gadget.

### DESCRIPTION OF DRAWINGS AND IMAGES

FIG. 1 is a hand drawing seen from the side with all pertinent markings and approximate measurements: It basically shows how is constructed and names the important parts for better understanding.

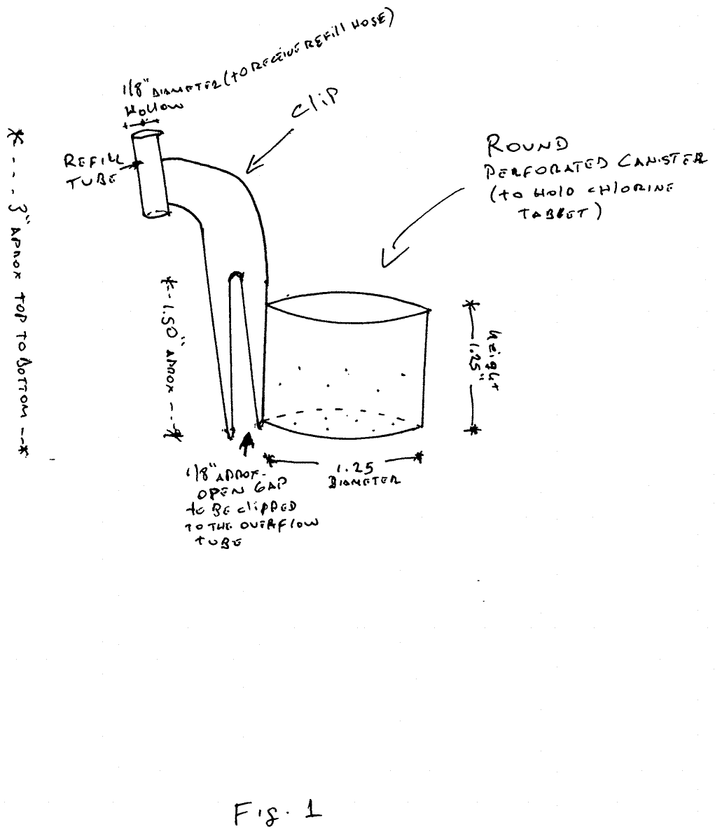

FIG. 2 is also a hand drawing seen from the side but without any markings or measurements: it is a clean representation of the invention itself.

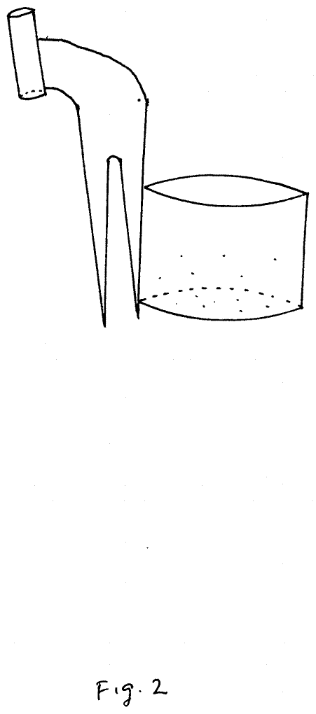

FIG. 3 is a picture of the actual prototype: Shows the Toilet Chlorinator and Sanitizer as a one piece gadget seen from the side.

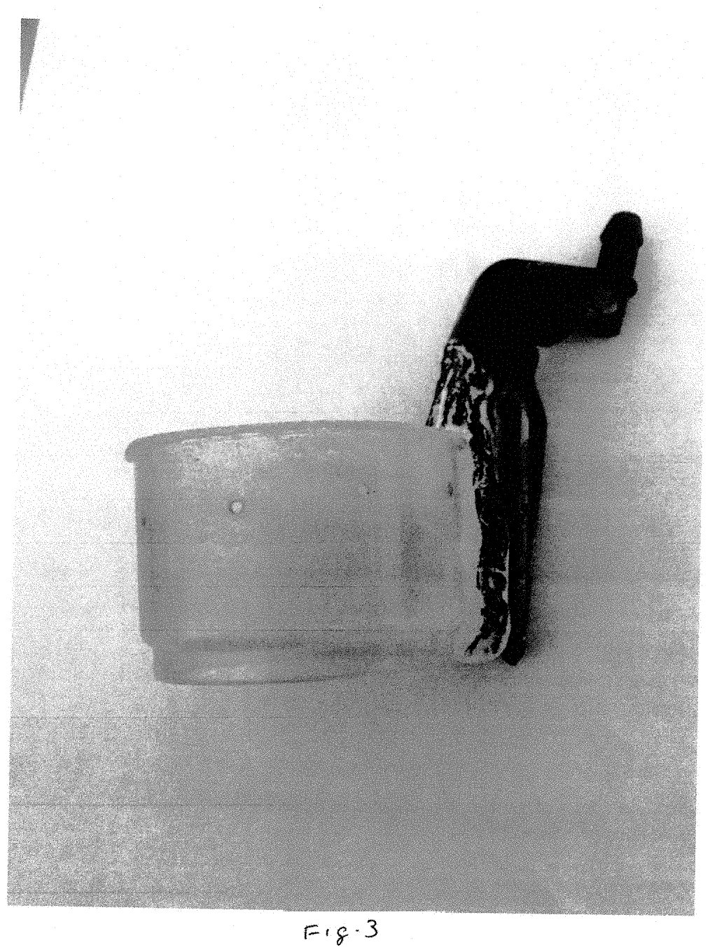

FIG. 4 is also a picture of the actual prototype seen from the top: This figure shows better the round perforated canister part (attached to the clip part) where the chlorine tablet goes.

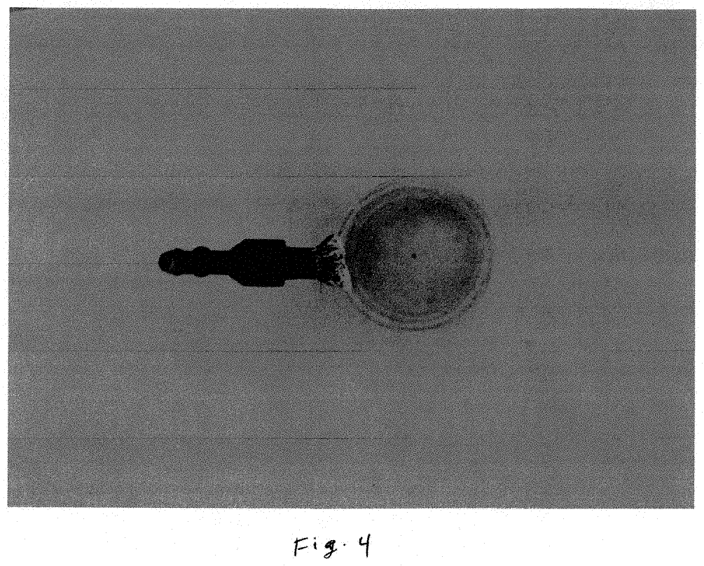

FIG. 5 is a picture of the prototype fully functional: This picture shows the Toilet Chlorinator and Sanitizer in normal operation holding a chlorine tablet inside a toilet water tank.

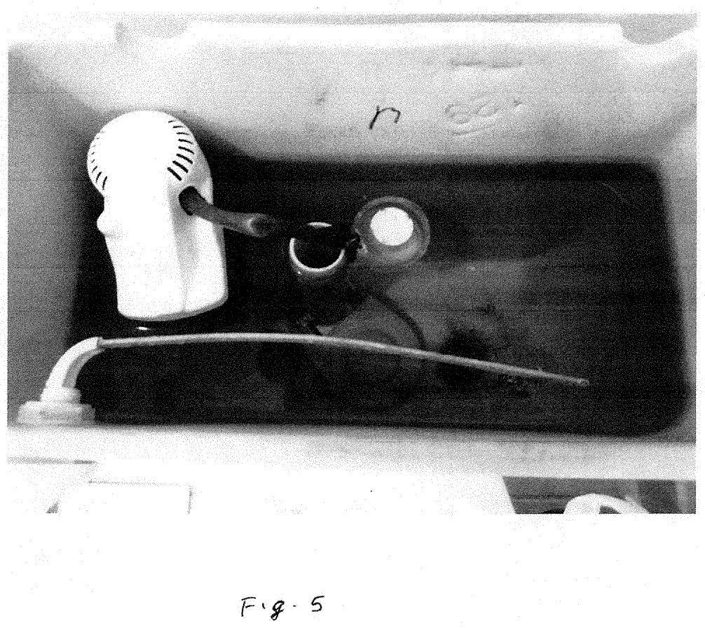

FIG. 6 is a picture of a typical toilet parts: This picture is to be use as a reference to identify a typical toilet and its parts.

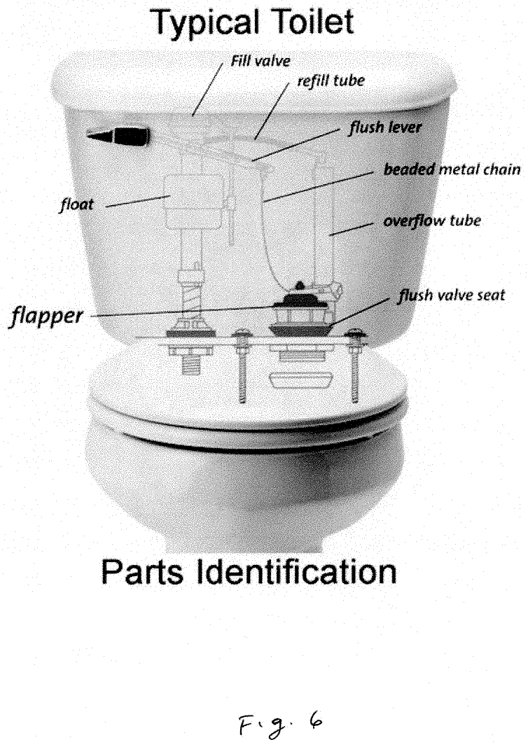

1. A one piece apparatus to be used as a toilet cleaner and sanitizer, the apparatus comprising:
A clip that can be attached to a typical toilet overflow tube; and a perforated canister attached to the clip to be use as a holder where a person can place a chlorine tablet or a similar cleaning agent.
